(19) United States
(12) Patent Application Publication
(10) Pub. No.: US 2015/0109771 A1
(43) Pub. Date: Apr. 23, 2015

(54) LIGHT EMITTING DIODE LIGHT TUBE

(71) Applicant: Lextar Electronics Corporation, Hsinchu, TW (US)

(72) Inventor: Sheng-Hung LIN, New Taipei City (TW)

(21) Appl. No.: 14/510,132

(22) Filed: Oct. 9, 2014

(30) Foreign Application Priority Data
Oct. 23, 2013 (TW) 102138286
Mar. 26, 2014 (TW) 103111287

(51) Int. Cl. F21K 99/00; F21V 13/02

(52) U.S. Cl. CPC F21K 9/54; F21V 13/02; F21K 9/56; F21Y 2101/02
USPC 362/223

(57) ABSTRACT

A light emitting diode (LED) light tube includes a substrate, a plurality of light emitting diodes (LEDs), a light diffusing plate, an organic yellow fluorescent powder and a hollow tube. The substrate, the LEDs and the light diffusing plate are disposed in the hollow tube. The organic yellow fluorescent powder is doped in the light diffusing plate. The LEDs are lined up on a surface of the substrate. The light diffusing plate are disposed facing to the LEDs, in which the light diffusing plate includes a plurality of microstructures located on positions opposite to the LEDs, so as to diffuse the light emitted from the LEDs.

### RELATED APPLICATIONS

This application claims priority to Taiwan Application Serial Numbers 102138286, filed Oct. 23, 2013, and 103111287, filed Mar. 26, 2014, which are herein incorporated by reference.

### BACKGROUND

1. Field of Invention

The present disclosure relates to a light emitting device, and more particularly, to a light emitting diode (LED) light tube.

2. Description of Related Art

Fluorescent light tubes emitting incandescent light currently dominate the application of indoor illumination. The traditional fluorescent light tube is a sealed gas discharge tube, which emits “light” by generating a gas discharge state with a current (in fact accelerate electrons) conducted through the tube. The fluorescent light tube consumes more energy because excessive heat is generated from the light lighting through the gas discharge process.

To improve a photoelectric conversion efficiency of the fluorescent light tube, using a light emitting diode (LED) light tube becomes an inevitable trend for featuring low energy consumption and long lifetime. However, since the light emitted from the LED is more concentrated than that of the fluorescent light tube, it is required to arrange a large number of LEDs (e.g., LED chips) in the LED light tube to improve light emitting uniformity of the LED light tube, which results in high production cost.

### SUMMARY

An aspect of the present disclosure provides a light emitting diode (LED) light tube to solve the problems of the prior art.

According to one embodiment of the present disclosure, a LED light tube is provided, which includes a substrate having a major axis and a minor axis, a plurality of LEDs, a light diffusing plate, an organic yellow fluorescent powder and a hollow tube. The plurality of LEDs are sequentially lined up on a surface of the substrate along the major axis direction, and a distance between two of the LEDs adjacent to each other is a first pitch P1. Further, the light diffusing plate is disposed over the LEDs and has a plurality of light diffusing regions. Each of the light diffusing regions corresponds to and over a light emitting path of one of the LEDs, and each of the light diffusing regions includes a plurality of microstructures spaced from each other and parallel to the minor axis and facing to the LEDs. The organic yellow fluorescent powder is disposed at the light emitting paths of the LEDs. The LEDs are configured to emit light having a first wavelength. The organic yellow fluorescent powder is configured to convert a portion of the light having the first wavelength emitted by the LEDs to light having a second wavelength, and thereby the light having the second wavelength and the light having the first wavelength, which is not converted by the organic yellow fluorescent powder, are mixed to form white light. The hollow tube covers the substrate, the LEDs and the light diffusing plate, in which a vertical distance between each of the LEDs and a surface of the hollow tube is A. A light emitting uniformity of the LED light tube is greater than or equal to 90% when a ratio of A to P1 satisfies a relation 0.6≧A/P1≧0.45.

According to one embodiment of the present disclosure, the microstructures are V-shaped grooves.

According to one embodiment of the present disclosure, a distance between two of the microstructures adjacent to each other is a second pitch P2, and 0.1 mm≦P2≦2 mm.

According to one embodiment of the present disclosure, the V-shaped groove has a first surface and second surface adjacent to the first surface, and an included angle between the first surface and the second surface is in a range of 36° to 59°.

According to one embodiment of the present disclosure, the included angle between the first surface and the second surface is 50°.

According to one embodiment of the present disclosure, the light diffusing regions at a surface of the light diffusing plate are adjacent to or spaced from each other.

According to one embodiment of the present disclosure, the light diffusing plate is made of a light permeable plastic material.

According to one embodiment of the present disclosure, the organic yellow fluorescent powder is doped in the light diffusing plate.

According to one embodiment of the present disclosure, the light diffusing plate has a first surface and a second surface opposite to each other, and the first surface faces the LEDs, and the organic yellow fluorescent powder is coated on the first surface of the light diffusing plate or the second surface of the light diffusing plate.

According to one embodiment of the present disclosure, the LED light tube further includes a light transmitting board, and the organic yellow fluorescent powder is doped in the light transmitting board, and the light diffusing plate has a first surface and a second surface opposite to each other, and the first surface faces the LEDs, and the light transmitting board faces the first surface of the light diffusing plate or the second surface of the light diffusing plate.

As mentioned above, in the LED light tube of the present disclosure, the light diffusing plate is disposed over the light emitting paths of the LEDs to diffuse a light pattern emitted from the LEDs toward both sides. Further, the ratio of the vertical distance A between the LED and the hollow tube to the first pitch P1 between two of the LEDs adjacent to each other is controlled to be in a range of 0.45 to 0.6, and thus the number of the LEDs of the present disclosure can be decreased but the uniformity of the LED light tube is still greater than or equal to 90%.

### BRIEF DESCRIPTION OF THE DRAWINGS

The invention can be more fully understood by reading the following detailed description of the embodiment, with reference made to the accompanying drawings as follows:

FIG. 1 is a stereoscopic view of a light emitting diode (LED) light tube according to one embodiment of the present disclosure.

FIG. 2 is a cross-sectional view of FIG. 1 along a line BB′ according to one embodiment of the present disclosure.

FIG. 3 is a cross-sectional view of FIG. 1 along the line BB′ according to another embodiment of the present disclosure.

FIG. 4 is a cross-sectional view of an organic yellow fluorescent powder coated on a light diffusing plate according to one embodiment of the present disclosure.

FIG. 5 is a cross-sectional view of an organic yellow fluorescent powder coated on a light diffusing plate according to another embodiment of the present disclosure.

FIG. 6 is a cross-sectional view of an organic yellow fluorescent powder doped in a light transmitting board according to one embodiment of the present disclosure.

FIG. 7 is a cross-sectional view of an organic yellow fluorescent powder doped in a light transmitting board according to another embodiment of the present disclosure.

FIGS. 8-10 are light pattern schematic diagrams emitted from the light emitting diodes and respectively diffused by various microstructures with different included angles.

### DETAILED DESCRIPTION

The following embodiments are disclosed with accompanying diagrams for detailed description. For illustration clarity, many details of practice are explained in the following descriptions. However, it should be understood that these details of practice do not intend to limit the present invention. That is, these details of practice are not necessary in parts of embodiments of the present invention. Furthermore, for simplifying the drawings, some of the conventional structures and elements are shown with schematic illustrations.

It is noted that in the specification, “uniformity” refers to, when a light emitting diode (LED) light tube emits light, a ratio of a minimum luminance of its surface to an average luminance. “High uniformity” of lighting means that visual feeling of human eyes is more comfortable. “Low uniformity” of lighting means that it is easy to increase visual fatigue. Therefore, uniformity of lighting is close to 1 as possible. High uniformity in the specification refers to a LED light tube with uniformity more than 90%.

In the following embodiments, a LED light tube is provided, which exhibits uniformity greater than 90% by disposing a light diffusing plate configured to diffuse light emitted from LEDs and then mixing light through an organic yellow fluorescent powder, and controlling a ratio of a distance between the LEDs to a distance between each of the LEDs and the tube body, and it will be described in detail below.

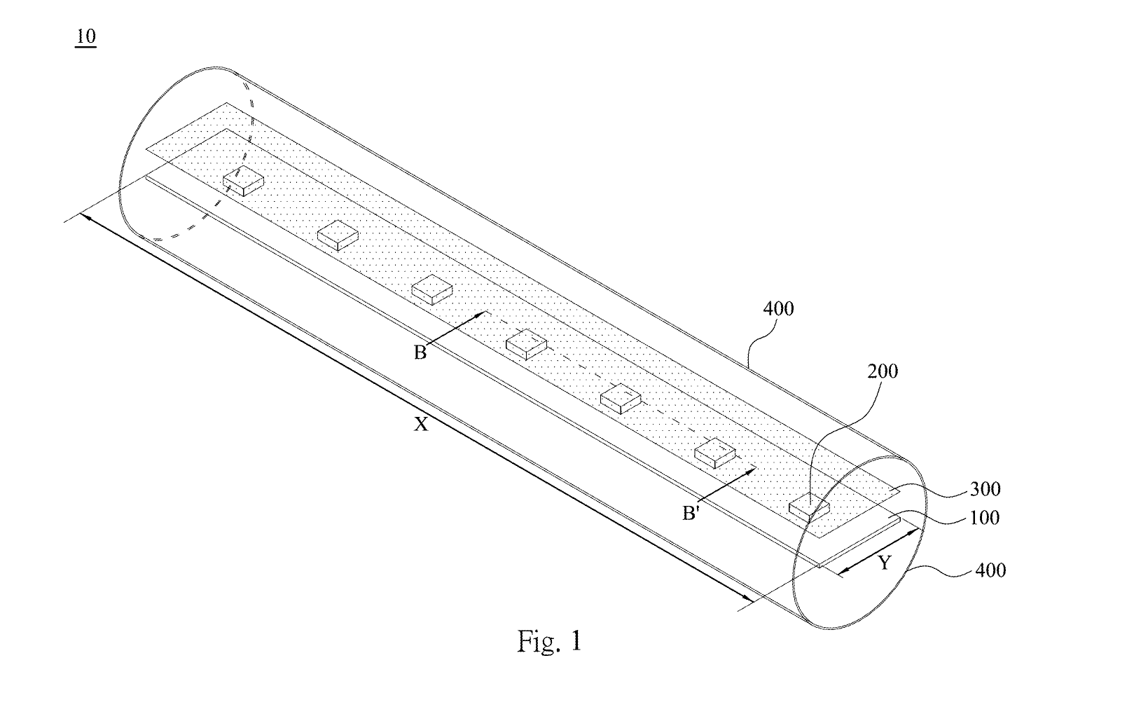

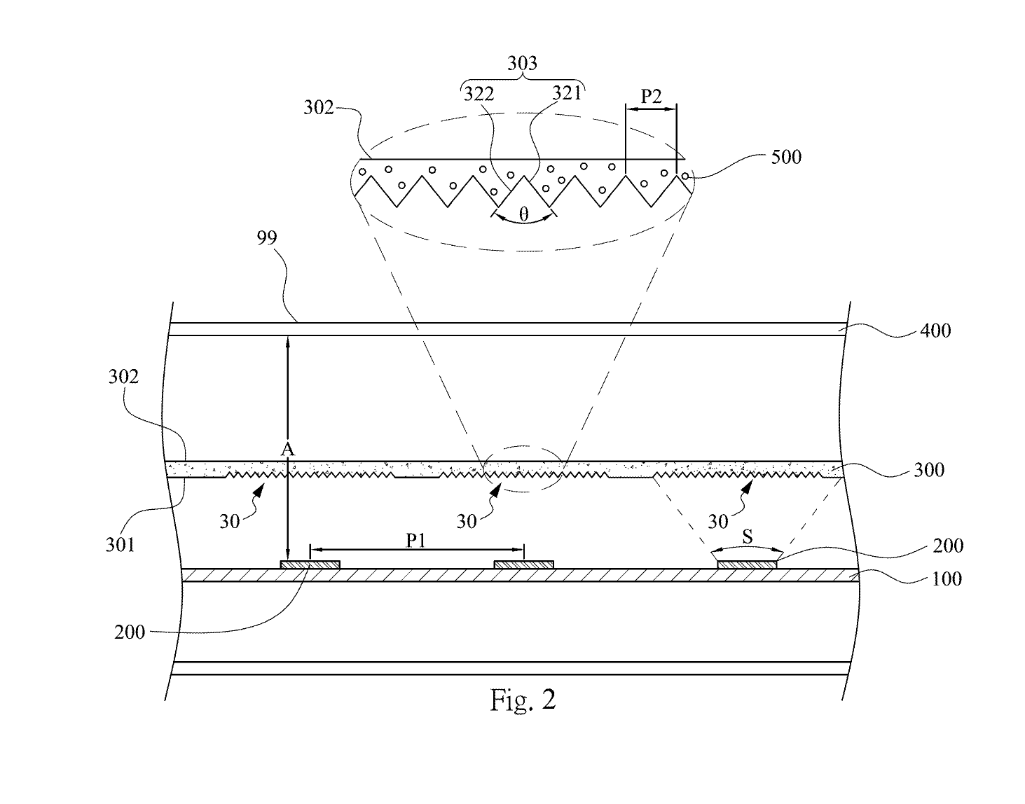

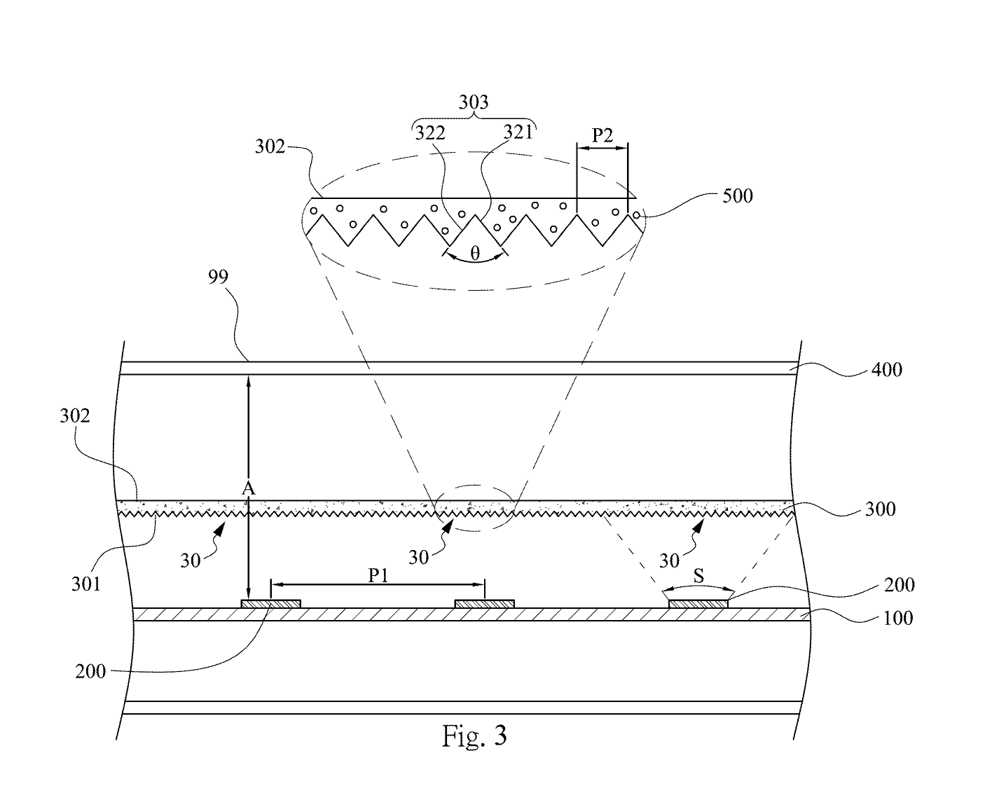

Referring to FIGS. 1-3, FIG. 1 is a stereoscopic view of a LED light tube according to one embodiment of the present disclosure, and FIG. 2 is a cross-sectional view of FIG. 1 along a line BB′ according to one embodiment of the present disclosure, and FIG. 3 is a cross-sectional view of FIG. 1 along the line BB′ according to another embodiment of the present disclosure. For convenience of description, electrical connectors at two ends of the light tube are omitted in FIG. 1. Since internal elements cannot be actually viewed from outside of the LED light tube, FIG. 1 depicts a perspective view of main internal elements of the LED light tube. As shown in FIG. 1, the LED light tube 10 includes a substrate 100, a plurality of LEDs 200, a light diffusing plate 300, a hollow tube 400 and an organic yellow fluorescent powder 500 (as shown in FIG. 2 and FIG. 3).

The hollow tube 400 may be a cylindrical tube, and its shape may be similar to a shape of a fluorescent tube but not limited thereto. The hollow tube 400 of the embodiment is used to cover the substrate 100, the plurality of LEDs 200 and the light diffusing plate 300. That is, the substrate 100, the plurality of LEDs 200 and the light diffusing plate 300 are located inside a cavity of the hollow tube 400.

The substrate 100 is disposed in the hollow tube 400 and has a major axis X and a minor axis Y. The plurality of LEDs 200 are lined up on a surface of the substrate 100. In the embodiment, the plurality of LEDs 200 are sequentially spaced with an equal interval on the surface of the substrate 100 along the major axis X direction so as to let the LED light tube 10 emit a light pattern with high uniformity. A distance between two of the LEDs 200 adjacent to each other is a first pitch P1.

The light diffusing plate 300 has a first surface 301 and a second surface 302 opposite to each other. The first surface 301 faces the substrate 100 and the LEDs 200, and the second surface 302 faces an inner wall surface of the hollow tube 400. The light diffusing plate 300 may be made of a light permeable plastic material to appropriately diffuse the light pattern emitted from the LEDs 200. Specifically, the first surface 301 of the light diffusing plate 300 has a plurality of light diffusing regions 30, and each of the light diffusing regions 30 includes a plurality of microstructures 303. Each of the light diffusing regions 30 corresponds to and disposed over a light emitting path S of one of the LEDs 200, in which area included by S represents the light emitting path, and the microstructures 303 may face each of the LEDs 200, such that the light emitted from each of the LEDs 200 may be appropriately diffused by the microstructures 303 of each of the light diffusing regions 30.

In one embodiment of FIG. 2, the light diffusing regions 30 are spaced from each other, and a distance between two of the light diffusing regions 30 adjacent to each other is less than the first pitch P1 between two of the LEDs 200 adjacent to each other. In another embodiment of FIG. 3, the light diffusing regions 30 are adjacent to each other; that is, the microstructures 303 of the light diffusing regions 30 are continuously distributed on the first surface 301 of the light diffusing plate 300.

As shown in FIGS. 2-3, each of the microstructures 303 is a V-shaped groove parallel to the minor axis and includes a first surface 321 and a second surface 322 adjacent to each other, and an included angle θ between the first surface 321 and the second surface 322 may be in a range of 36° to 59°. In another embodiment of the present disclosure, the included angle θ between the first surface 321 and the second surface 322 is 50°. In addition, a distance between two of the microstructures 303 adjacent to each other is a second pitch P2. In the embodiment that the microstructures 303 are V-shaped grooves, the second pitch P2 is a distance between bottoms of the two adjacent grooves, and 0.1 mm≦P2≦2 mm.

The organic yellow fluorescent powder 500 is disposed at the light emitting paths S of the LEDs 200 and configured to covert light emitted by the LEDs 200. Specifically, the LEDs 200 may emit light having a first wavelength, and the organic yellow fluorescent powder 500 may convert a portion of the light having the first wavelength emitted by the LEDs to light having a second wavelength, and the light having the second wavelength and the light having the first wavelength, which is not converted by the organic yellow fluorescent powder, are mixed to form white light. In practical application of a product, the LEDs 200 may be blue LEDs 200 or high color temperature LEDs 200 with a color temperature greater than or equal to 8000K, and the first wavelength of the light is in a range of blue light. The organic yellow fluorescent powder 500 may convert blue light to yellow light having the second wavelength, and yellow light and blue light, which is not coverted by the organic yellow fluorescent powder 500, are mixed to form white light. In a various embodiment, the organic yellow fluorescent powder 500 has a chemical general formula below:

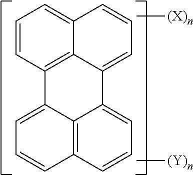

in which the organic yellow fluorescent powder 500 is a polymer compound having a conjugated structure, and X and Y represent functional groups having the conjugated structure able to transfer electrons. For example, the functional groups may be but not limited to aromatic, alkenyl or carbonyl groups. N is a natural number.

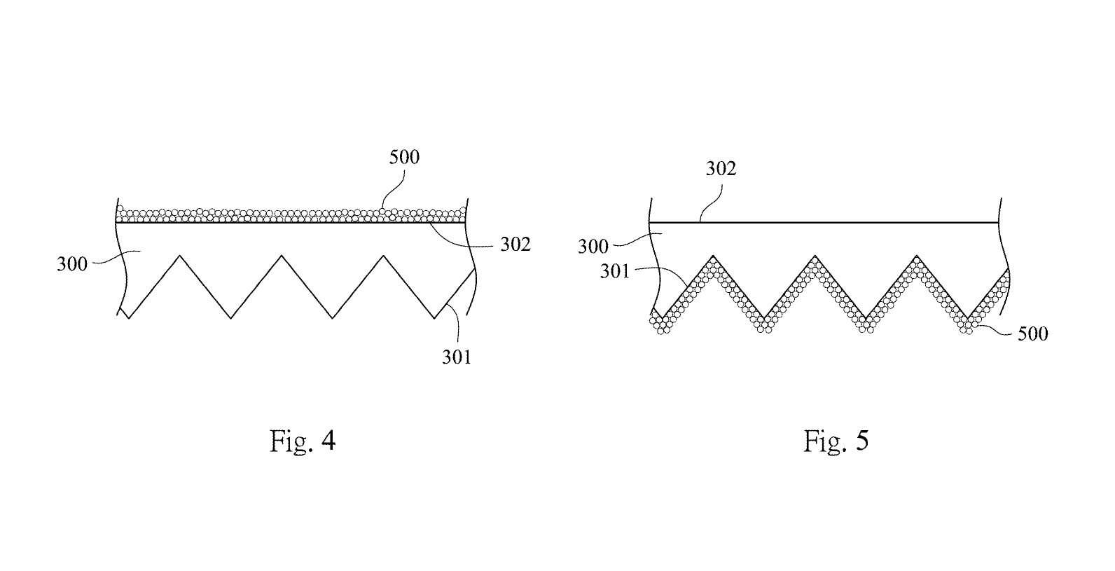

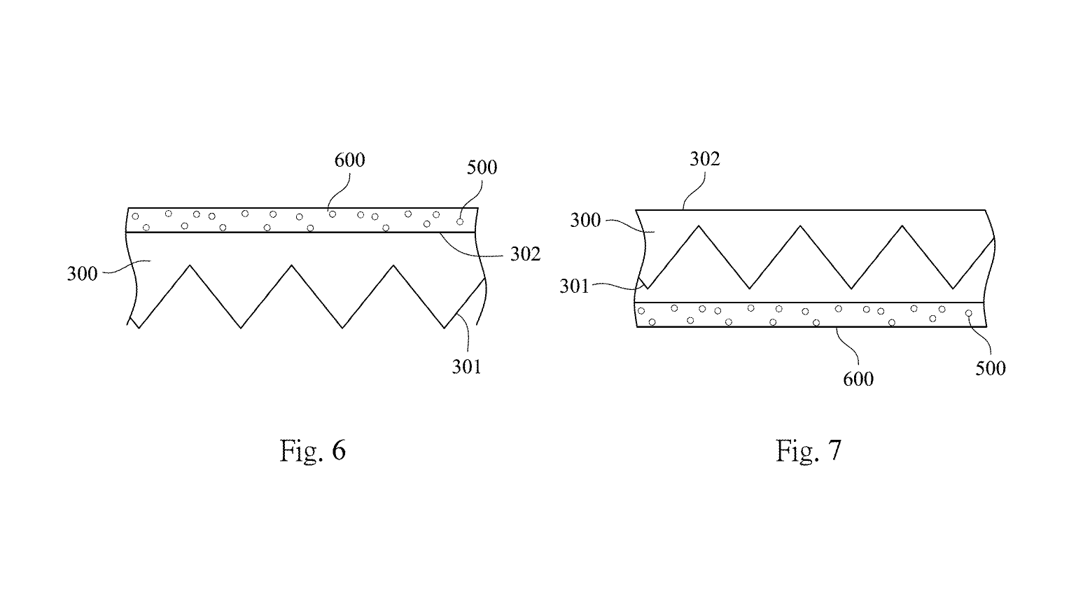

As shown in the embodiments of FIG. 2 and those of FIG. 3, the organic yellow fluorescent powder 500 may be doped in the light diffusing plate 300. As such, the light diffusing plate 300 may exhibit light diffusion and light mixing to save cost, but the present disclosure is not limited thereto. In other embodiments, the organic yellow fluorescent powder 500 is formed on a surface of the light diffusing plate 300 by a coating process. FIG. 4 and FIG. 5 are the embodiments that the organic yellow fluorescent powder 500 is coated on the second surface 302 and the first surface 301. As shown in FIG. 4, the organic yellow fluorescent powder 500 is coated on the second surface 302 of the light diffusing plate 300. The second surface 302 of the light diffusing plate 300 does not have the microstructures 303, and the second surface 302 is relatively flat compared to the first surface 301, such that the organic yellow fluorescent powders 500 may be uniformly formed on the second surface 302.

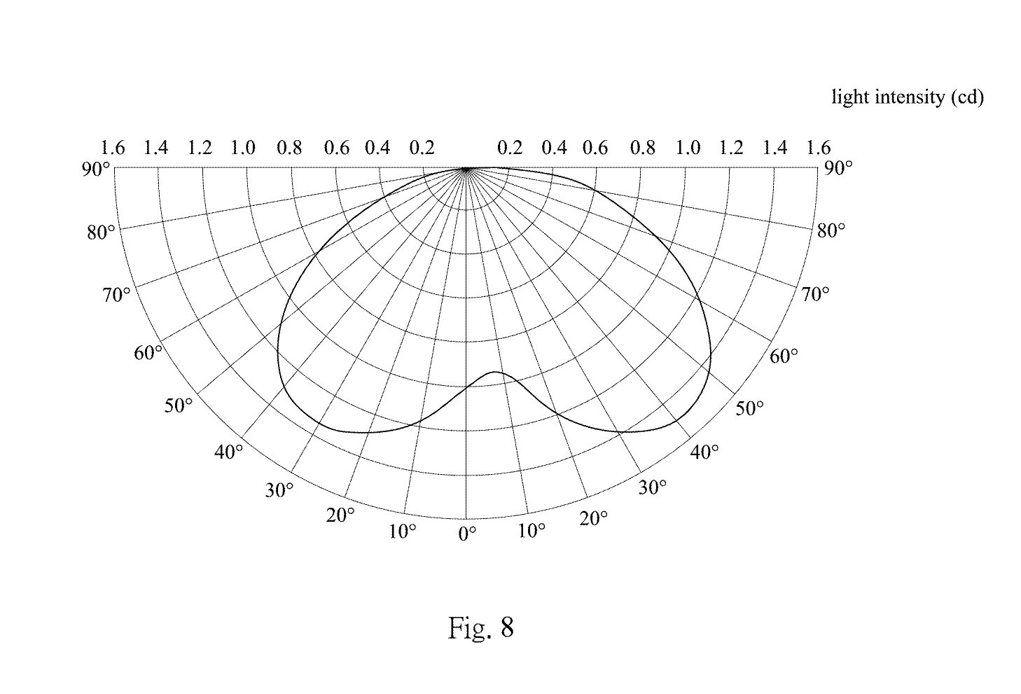

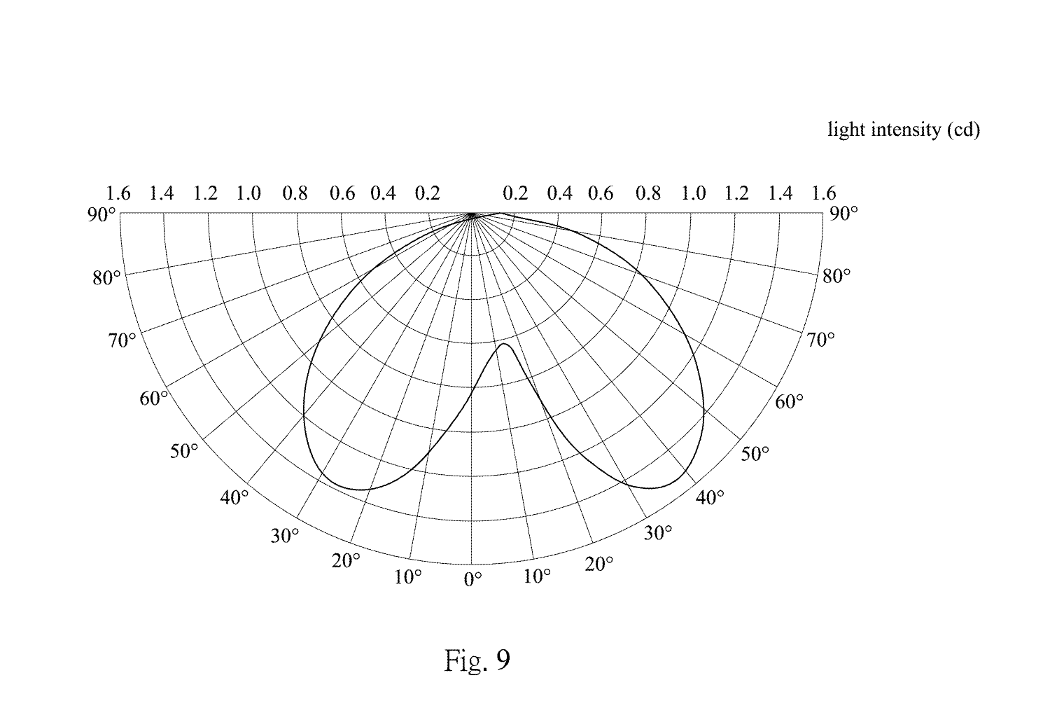

Subsequently, please refer to FIG. 6 and FIG. 7, which are different embodiments that the organic yellow fluorescent powder 500 is doped in a light transmitting board 600. As shown in FIG. 6, the LED light tube 10 further includes the light transmitting board 600, which is different from the light diffusing plate 300. The organic yellow fluorescent powders 500 may be doped in the light transmitting board 600, and the light transmitting board 600 may flexibly face the first surface 301 of the light diffusing plate 300 or the second surface 302 thereof. As shown in FIG. 6, the light transmitting board 600 faces and is almost bonded with the second surface 302 of the light diffusing plate 300, and thus there is almost no gap between the second surface 302 and the light transmitting board 600. As shown in FIG. 7, the light transmitting board 600 faces the first surface 301 of the light diffusing plate 300, and there is a gap between the first surface 301 and the light transmitting board 600.

Continuously referring to FIG. 2 and FIG. 3, the included angle θ between the first surface 321 and the second surface 322 of each of the microstructures 303 affects the light pattern emitted from the LEDs 200. For example, when the included angle θ is 50±1°, the light pattern emitted from the LEDs 200 is obviously diffused toward both sides in a direction of 35°, as shown in FIG. 5. In this case, a middle part of the light of the LEDs 200 diffused by the microstructures 303 of the light diffusing regions 30 is weak. Therefore, in the embodiment, more LEDs 200 may be arranged to let the LED light tube 10 exhibit high uniformity by overlapping light patterns of the LEDs 200 diffused by the microstructures 303 of the light diffusing regions 30 and then converting the light emitted from the LEDs 200 to white light through the organic yellow fluorescent powder 500.

Next, referring to Table 1, which includes a simulation result of uniformity of a conventional LED light tube without a light diffusing plate and that of the LED light tube of the embodiment in practical applications. A is the vertical distance between the LED 200 and the hollow tube 400, and P1 is the distance between two of the LEDs 200 adjacent to each other.

TABLE 1
Simulation Results of Uniformity

| First pitch P1 | A/P1 | Light diffusing plate | Uniformity |
|---|---|---|---|
| 15 mm | 1.2 | None | 92.5% |
| 30 mm | 0.6 | None | 69% |
| 30 mm | 0.6 | Having | 90% |
| 35 mm | 0.52 | None | 55% |
| 35 mm | 0.52 | Having | 91% |
| 40 mm | 0.45 | None | 49% |
| 40 mm | 0.45 | Having | 91.5% |

As listed in Table 1, when the vertical distance A between the LED 200 and the hollow tube 400 is 18 mm, the first distance P1 of the adjacent LEDs 200 of the conventional LED light tube without the light diffusing plate 300 of the present disclosure having the light diffusing regions 30 having the microstructures 303 over light emitting paths S of the LEDs should be shortened to 15 mm to exhibit light emitting uniformity greater than 90%. Compared to the present disclosure, since the light diffusing plate 300 having the light diffusing regions 30 having the microstructures 303 is disposed over the light emitting paths S of the LEDs 200, light emitting uniformity at a light exit surface 99 can be greater than or equal to 90% though the first pitch P1 between the adjacent LEDs 200 is in a range of 30 mm to 40 mm (i.e., A/P1 in a range of 0.45 to 0.6).

It should be stated that the values provided from Table 1 is not limited to the scope of the present disclosure. In some embodiments, the first pitch P1 is in a range of 10 mm to 45 mm. Further, a distance between the LEDs 200 and the microstructures 303 may be in a range of 2 mm to 38 mm, and a distance of LEDs 200 and the light exit surface 99 of the hollow tube 400 may be in a range of 5 mm to 40 mm. As such, when 0.6≧A/P1≧0.45, the light emitting uniformity at a light exit surface 99 of the LED light tube 10 can be greater than or equal to 90% through light diffusion of the light diffusing plate 300 and light mixing of the organic yellow fluorescent powder 500.

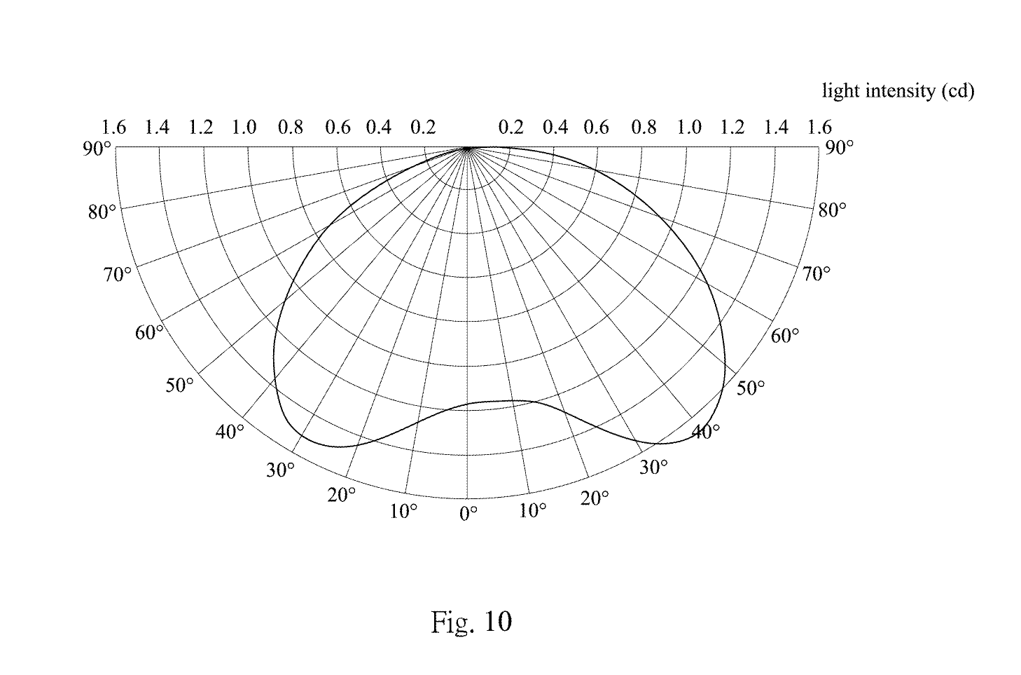

As mentioned above, because of the design of the microstructures 303 of the light diffusing regions 30 of the light diffusing plate 300, not only the LED light tube 10 exhibits the uniformity greater than or equal to 90% but also the number of the LEDs 200 can be decreased to reduce production cost of the LED light tube 10. It is worth mentioning that the microstructures 303 of the embodiment is configured to covert the light pattern emitted from the LEDs 200 to the light pattern diffused toward both sides. For more understanding, referring to FIGS. 8-10, which are light pattern schematic diagrams emitted from the LEDs and respectively diffused by various microstructures with different included angles.

As shown in FIG. 8, when the included angle θ between the first surface 321 and the second surface 322 of the microstructure 303 is 45°, the light pattern of the LEDs 200 is in a range of about +/−60°, and light intensity at about 37° is stronger. Therefore, the microstructure 303 of FIG. 8 can be used to diffuse the light pattern emitted from the LEDs 200 toward both sides, and thus the number of the LEDs 200 of the LED light tube 10 can be decreased and the uniformity is still greater than or equal to 90%.

As shown in FIG. 9, the included angle θ between the first surface 321 and the second surface 322 of the microstructure 303 is 50°. The difference between FIG. 9 and FIG. 8 is that the light pattern of the LEDs 200 of FIG. 9 diffused by the light diffusing plate 300 is more concentrated at both sides, and light intensity at a middle part is weaker than that of FIG. 8. Similarly, since the microstructures 303 of FIG. 8 can be used to diffuse the light pattern emitted from the LEDs 200 toward both sides, the amount of the LEDs 200 of the LED light tube 10 can be reduced and the uniformity is still greater than or equal to 90%.

As shown in FIG. 10, the included angle θ between the first surface 321 and the second surface 322 of the microstructure 303 is 55°. The difference between FIG. 10 and FIG. 8 is that light intensities at both sides and middle parts of the light pattern of the LED 200 of FIG. 10 diffused by the light diffusing plate 300 are greater about 0.2 Cd than those of FIG. 8. Similarly, since the microstructures 303 of FIG. 10 can be utilized to diffuse the light pattern emitted from the LEDs 200 toward both sides, the number of the LEDs 200 of the LED light tube 10 can be decreased and the uniformity is still greater than or equal to 90%.

In summary, in the present disclosure, the light diffusing plate disposed in the LED light tube can be used to diffuse concentrated light pattern emitted from the LEDs toward both sides. Also, the ratio of the vertical distance A between the LED and the hollow tube to the pitch P1 between two of the LEDs adjacent to each other is controlled to be in a range of 0.45 to 0.6, so as to reduce the number of the LEDs of the present disclosure, but the uniformity of the LED light tube is still greater than or equal to 90%. One aspect is to reduce production cost, and another aspect is to maintain the light emitting uniformity of the LED light tube.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light emitting diode (LED) light tube, comprising:
a substrate having a major axis and a minor axis;
a plurality of light emitting diodes (LEDs) sequentially lined up on a surface of the substrate along the major axis direction, and a distance between two of the LEDs adjacent to each other is a first pitch P1, and the LEDs being configured to emit light having a first wavelength;
a light diffusing plate disposed over the LEDs, and having a plurality of light diffusing regions, and each of the light diffusing regions corresponding to and over a light emitting path of one of the LEDs, and each of the light diffusing regions comprising a plurality of microstructures spaced from each other and parallel to the minor axis and facing to the LEDs,
an organic yellow fluorescent powder disposed at the light emitting paths of the LEDs, and the organic yellow fluorescent powder being configured to convert a portion of the light having the first wavelength emitted by the LEDs to light having a second wavelength, and thereby the light having the second wavelength and the light having the first wavelength, which is not converted by the organic yellow fluorescent powder, being mixed to form white light;
a hollow tube covering the substrate, the LEDs and the light diffusing plate, wherein a vertical distance between each of the LEDs and a surface of the hollow tube is A,
wherein a light emitting uniformity of the LED light tube is greater than or equal to 90% when a ratio of A to P1 satisfies a relation 0.6≧A/P1≧0.45.

2. The LED light tube of claim 1, wherein the microstructures are V-shaped grooves.

3. The LED light tube of claim 2, wherein the V-shaped groove has a first surface and second surface adjacent to the first surface, and an included angle between the first surface and the second surface is in a range of 36° to 59°.

4. The LED light tube of claim 3, wherein the included angle between the first surface and the second surface is 50°.

5. The LED light tube of claim 1, wherein a distance between two of the microstructures adjacent to each other is a second pitch P2, and 0.1 mm≦P2≦2 mm.

6. The LED light tube of claim 5, wherein the light diffusing regions at a surface of the light diffusing plate are adjacent to or spaced from each other.

7. The LED light tube of claim 6, wherein the light diffusing plate is made of a light permeable plastic material.

8. The LED light tube of claim 1, wherein the organic yellow fluorescent powder is doped in the light diffusing plate.

9. The LED light tube of claim 1, wherein the light diffusing plate has a first surface and a second surface opposite to each other, and the first surface faces the LEDs, and the organic yellow fluorescent powder is coated on the first surface of the light diffusing plate or the second surface of the light diffusing plate.

10. The LED light tube of claim 1, further comprising a light transmitting board, and the organic yellow fluorescent powder is doped in the light transmitting board, and the light diffusing plate has a first surface and a second surface opposite to each other, and the first surface faces the LEDs, and the light transmitting board faces the first surface of the light diffusing plate or the second surface of the light diffusing plate.
